(19) United States
(12) Patent Application Publication
(10) Pub. No.: US 2018/0061332 A1
(43) Pub. Date: Mar. 1, 2018

(54) DRIVING DEVICE OF AUTOMATICALLY ADJUSTING FRAME RATE FOR ACTIVE MATRIX ELECTROPHORETIC DISPLAY AND DRIVING METHOD THEREOF

(71) Applicant: ULTRA CHIP, INC., Taipei City (TW)

(72) Inventor: Chih-Cheng CHUANG, Taipei City (TW)

(21) Appl. No.: 15/384,341

(22) Filed: Dec. 20, 2016

(30) Foreign Application Priority Data
Aug. 24, 2016 (CN) 201610712310.5
Nov. 9, 2016 (CN) 201610983684.0

(51) Int. Cl. G09G 3/34

(52) U.S. Cl. CPC G09G 3/344; G09G 2340/0435; G09G 2310/08

(57) ABSTRACT

A driving device of automatically adjusting a frame rate for an active matrix electrophoretic display and a driving method thereof are provided. The driving method has a phase signal generation step for generating a plurality of phase signals, a phase signal processing step for processing an Nth phase signal and an (N+1)th phase signal, an union step, and an output step for outputting a driving voltage selecting signal, a latch signal and a gate driver control signal. Thus, the power consumption can be reduced by analyzing to maintain or reduce the frame rate of the active matrix electrophoretic display.

### FIELD OF THE INVENTION

The present invention relates to a driving device for a display and a driving method thereof, and more particularly to a driving device of automatically adjusting a frame rate for an active matrix electrophoretic display and a driving method thereof.

### BACKGROUND OF THE INVENTION

Common Electro-Phoretic Display (EPD) is controlled by a charged pigment to achieve an experience like reading a paper with a bistable characteristic. The power consumption occurs at updating an image, and the original state is kept without updating image, which called reflective display. The reflective display is easily read in a strong light, and the eye does not easily get tired, which is suitable for reading books and product labels. A driving principle of EPD is that different driving voltages are given according to different image states including a former state display image (OLD Data) and an updating display image (NEW Data). Different driving voltage signal is given according to all combination changed form the former state display image to the updating display image. However, the power consumption of updating image is more concerned in the application of EPD. Therefore, the updating times can be increased at the same electric quantity if the power consumption of the updating image is reduced. That is, the useful life can be increased for the application of the electronic product label. Recently, updating image of EPD is adopted the same frame rate. The frame rate could impact the power consumption, such as low frame rate generates a low power consumption, but high frame rate with a high power consumption generates a good display effect (high comparison and clear graphics). Thus, the power consumption and the display effect cannot both be satisfied.

As a result, it is necessary to provide a driving device of automatically adjusting a frame rate for an active matrix electrophoretic display and a driving method thereof to solve the problems existing in the conventional technologies, as described above.

### SUMMARY OF THE INVENTION

A primary object of the present invention is to provide a driving device of automatically adjusting a frame rate for an active matrix electrophoretic display and a driving method thereof, which is determining to maintain or reduce a frame rate of the active matrix electrophoretic display by processing an Nth phase signal and an (N+1)th phase signal of the phase signals from a phase signal processor to achieve the effect of reducing power consumption.

The technical solution of the present invention is a driving device of automatically adjusting a frame rate for an active matrix electrophoretic display, which comprises: a driving voltage signal storage configured to store at least one driving voltage signal, wherein the at least one driving voltage signal is provided to drive an active matrix electrophoretic display to display at least one color, and a plurality of signal segments of each of the at least one driving voltage signal is divided by frames; a phase generator electrically connected to the driving voltage signal storage and configured to read the at least one driving voltage signal and sequentially generating a plurality of phase signals corresponded to the signal segments; a phase signal processor electrically connected to the phase generator and configured to accept the phase signals and processing an Nth phase signal and an (N+1)th phase signal of the phase signals whether the Nth phase signal and the (N+1)th phase signal are the same or not, and generating a processing result, wherein N is a positive integer; an image data storage unit configured to store an image data; a timing control unit connected to the image data storage unit, the phase generator and the phase signal processor, and configured to accept the image data, the phase signals and a final frame rate control signal, and operating to output at least one driving voltage selection signal, a latch signal, and a gate control signal; a source driver connected to the timing control unit and configured to charge a pixel capacitance by triggering an output voltage to convert through the latch signal; and a gate driver connected to the timing control unit and configured to output a voltage to the active matrix electrophoretic display according to a control of the gate control signal; wherein the phase signal processor generates a control signal which is configured to maintain or reduce a frame rate of the active matrix electrophoretic display according to the processing result.

In one embodiment of the present invention, the phase signal processor is configured to compare the Nth phase signal with the (N+1)th phase signal of the phase signals to determine whether the Nth phase signal and the (N+1)th phase signal are the same or not, and to generate a processing result.

In one embodiment of the present invention, the phase signal processor is configured to detect the Nth phase signal and the (N+1)th phase signal of the phase signals to determine whether the Nth phase signal and the (N+1)th phase signal are belonged to a driving voltage setting or not, and to generate a processing result, wherein the driving voltage setting has a setting voltage and a number of frames keeping the setting voltage.

In one embodiment of the present invention, the driving device further comprises a union circuit configured to get a union of a plurality of control signals generated through a plurality of the driving voltage signals, and operating to obtain the final frame rate control signal.

In one embodiment of the present invention, the driving device further comprises an intersection circuit configured to get an intersection of a plurality of control signals generated through a plurality of the driving voltage signals, and operating to obtain the final frame rate control signal.

In one embodiment of the present invention, the driving device further comprises a latch signal generator configured to output the latch signal to the source driver through the timing control unit.

In one embodiment of the present invention, the timing control unit has a single timing mode, and the control signal is provided to maintain a current frame rate of the single timing mode or to reduce the current frame rate of the single timing mode by reducing the number of the frames.

In one embodiment of the present invention, the timing control unit has a dual timing mode, and the control signal is provided to replace the two timing mode with each other.

To achieve the above object, the present invention provides a driving method of automatically adjusting a frame rate for an active matrix electrophoretic display, which comprises steps of: a phase signal generation step for reading at least one driving voltage signal and sequentially generating a plurality of phase signals corresponded to a plurality of signal segments, wherein the signal segments is divided by frames; a phase signal processing step for accepting the phase signals and processing an Nth phase signal and an (N+1)th phase signal of the phase signals whether the Nth phase signal and the (N+1)th phase signal are the same or not, and generating a processing result, and generating a control signal for maintaining or reducing a frame rate of the active matrix electrophoretic display according to the processing result, wherein N is a positive integer; and an output step for accepting the image data, the phase signals and a final frame rate control signal, and operating to output at least one driving voltage selection signal, a latch signal, and a gate control signal.

In one embodiment of the present invention, the phase signal processing step includes: comparing the Nth phase signal with the (N+1)th phase signal of the phase signals to determine whether the Nth phase signal and the (N+1)th phase signal are the same or not, and to generating a processing result.

In one embodiment of the present invention, the phase signal processing step includes: detecting the Nth phase signal and the (N+1)th phase signal of the phase signals to determine whether the Nth phase signal and the (N+1)th phase signal are belonged to a driving voltage setting or not, and generating a processing result, wherein the driving voltage setting has a setting voltage and a number of frames keeping the setting voltage.

In one embodiment of the present invention, the driving method further comprises a union step, after the phase signal processing step, for getting an union of a plurality of control signals generated through a plurality of the driving voltage signals, and operating to obtain the final frame rate control signal.

In one embodiment of the present invention, the driving method further comprises an intersection step, after the phase signal processing step, for getting an intersection of a plurality of control signals generated through a plurality of the driving voltage signals, and operating to obtain the final frame rate control signal.

In one embodiment of the present invention, the reduced frame rate of the active matrix electrophoretic display is 1/2 to 1/16 of the kept frame rate of the active matrix electrophoretic display in the phase signal processing step.

As described above, an Nth phase signal and an (N+1)th phase signal of the phase signals are processed by the phase signal processor according to the phase signals corresponded to the signal segments of each of the driving voltage signals, so as to determine to maintain or reduce a frame rate of the active matrix electrophoretic display. Thus, the conversion times of the outputting voltage of the source driver and the gate driver can be reduced to achieve the effect of reducing power consumption.

### DESCRIPTION OF THE DRAWINGS

FIG. 1 is a schematic view of a driving device of automatically adjusting a frame rate for an active matrix electrophoretic display according to the preferred embodiment of the present invention;

FIG. 2 is a flowchart of a driving method of automatically adjusting a frame rate for an active matrix electrophoretic display according to the preferred embodiment of the present invention;

FIG. 3 is another schematic view of a driving device of automatically adjusting a frame rate for an active matrix electrophoretic display according to the preferred embodiment of the present invention:

FIG. 4 is another flowchart of a driving method of automatically adjusting a frame rate for an active matrix electrophoretic display according to the preferred embodiment of the present invention;

FIGS. 5 to 8 are schematic views of a driving voltage signal and a control signal in a driving method of automatically adjusting a frame rate for an active matrix electrophoretic display; and

FIG. 9 is a schematic view of a control signal and final frame rate control signal in a driving method of automatically adjusting a frame rate for an active matrix electrophoretic display.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings, and thus the used directional terms are used to describe and understand the present invention, but the present invention is not limited thereto.

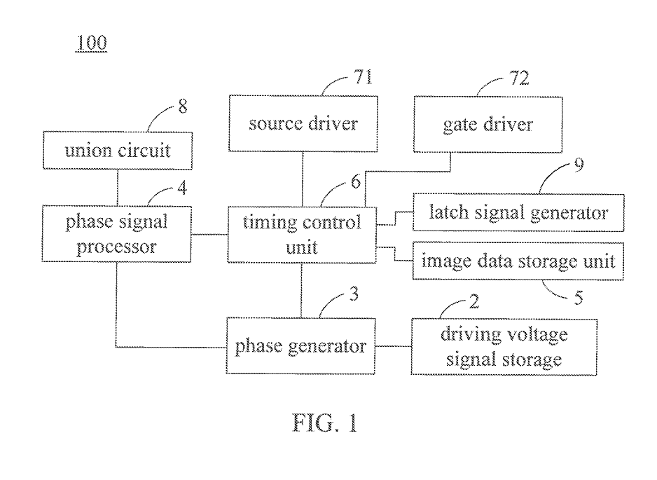

Refer to FIG. 1, which is a schematic view of a driving device 100 of automatically adjusting a frame rate for an active matrix electrophoretic display (not shown) according to the preferred embodiment of the present invention, wherein the driving device 100 has a driving voltage signal storage 2, a phase generator 3, a phase signal processor 4, an image data storage unit 5, a timing control unit 6, a source driver 71, a gate driver 72, an union circuit 8, and a latch signal generator 9. The detailed structure of each component, assembly relationships, and principle of operation in the present invention will be described in detail hereinafter.

Refer still to FIG. 1, the driving voltage signal storage 2 is configured to store a plurality of driving voltage signals, wherein each of the driving voltage signals is provided to drive an active matrix electrophoretic display to display at one color, such as a first driving voltage signal is provided to transmit to a common drive electrode, a second driving voltage signal is provided to drive the active matrix electrophoretic display to display a color of white, a third driving voltage signal is provided to drive the active matrix electrophoretic display to display a color of black, and a fourth driving voltage signal is provided to drive the active matrix electrophoretic display to display a color of red. In the preferred embodiment, a plurality of signal segments of each of the driving voltage signals is divided by frames.

Refer still to FIG. 1, the phase generator 3 electrically connects to the driving voltage signal storage 2, and the phase generator 3 is configured to read the driving voltage signals of the driving voltage signal storage 2, and sequentially generating a plurality of phase signals corresponded to the signal segments.

Refer still to FIG. 1, the phase signal processor 4 electrically connects to the phase generator 3, and the phase signal processor 4 is configured to accept the phase signals of the phase generator 3, and comparing an Nth phase signal and an (N+1)th phase signal of the phase signals whether the Nth phase signal and the (N+1)th phase signal are the same or not, and generating a processing result. For example, a first processing result is generated according to a first driving voltage signal, a second processing result is generated according to a second driving voltage signal, a third processing result is generated according to a third driving voltage signal, and a fourth processing result is generated according to a fourth driving voltage signal, wherein N is a positive integer, such as 1, 2, 3, 4, 5, 6, 7, 8, 9, or 10.

Furthermore, in other embodiment, the phase signal processor 4 also is configured to detect the Nth phase signal and the (N+1)th phase signal of the phase signals to determine whether the Nth phase signal and the (N+1)th phase signal are belonged to a driving voltage setting or not, and to generate a processing result, wherein the driving voltage setting has a setting voltage and a number of frames keeping the setting voltage.

Specifically, the content storage format of the driving voltage signal storage 2 can be divided into three settings, the first setting is fully expanded voltage setting, each of the driving voltage settings represents an “output voltage setting” of a frame, such as +11V, +11V, +11V, −11V, −11V, −11V, −11V . . . ; the second setting is a single voltage setting, each of the driving voltage settings has a setting voltage and a number of frames keeping the setting voltage, such as (+11V, 3 Frames), (−11V, 4 Frames), (+11V, 3 Frames) . . . ; the third setting is another kind of a single voltage setting, each of the driving voltage settings has a setting voltage, a number of frames keeping the setting voltage, and a number of repetitions of a group of the voltage settings, such as {(+11V, 3 Frames), (−11V, 4 Frames), Repeat 2 times}. The content storage format of the driving voltage signal storage 2 of the first setting, second setting, and third setting can be configured to compare the Nth phase signal with the (N+1)th phase signal of the phase signals to determine whether the Nth phase signal and the (N+1)th phase signal are the same or not, and to generate the processing result. The content storage format of the driving voltage signal storage 2 of the second setting, and third setting can be configured to detect the Nth phase signal and the (N+1)th phase signal of the phase signals to determine whether the Nth phase signal and the (N+1)th phase signal are belonged to a driving voltage setting or not, and to generate the processing result.

Refer still to FIG. 1, the phase signal processor 4 operates a control signal for maintaining or reducing a frame rate of the active matrix electrophoretic display according to each of the processing results, wherein the union circuit 8 is configured to get an union of a plurality of control signals generated through a plurality of the driving voltage signals, and operating to obtain the final frame rate control signal. A high level of the final frame rate control signal represents maintaining the frame rate, and a low level of the final frame rate control signal represents reducing the frame rate. For example, a first control signal is operated according to the first processing result, a second control signal is operated according to the second processing result, a third control signal is operated according to the third processing result, and a fourth control signal is operated according to the fourth processing result. Then a union of the first control signal, the second control signal, the third control signal, and the fourth control signal is gotten to obtain the final frame rate control signal.

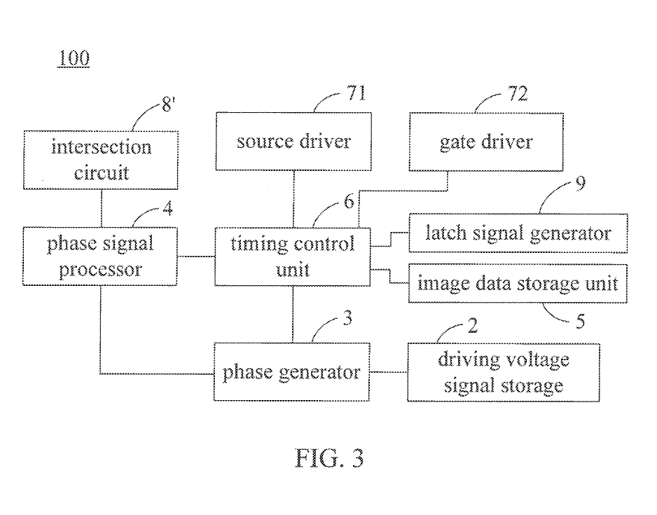

Refer to FIG. 3. In another preferred embodiment, the driving device 100 of automatically adjusting a frame rate has an intersection circuit 8′, and the intersection circuit 8′ is configured to get an intersection of a plurality of control signals generated through a plurality of the driving voltage signals, and operating to obtain the final frame rate control signal, wherein a high level of the final frame rate control signal represents reducing the frame rate, and a low level of the final frame rate control signal represents maintaining the frame rate.

Refer to FIG. 1, the image data storage unit 5 is configured to store an image data. In the preferred embodiment, the image data storage unit 5 is a display ram for storing the image displayed on the active matrix electrophoretic display.

Refer still to FIG. 1, the timing control unit 6 connects to the image data storage unit 5, the phase generator 3 and the phase signal processor 4, and the timing control unit 6 is configured to accept the image data, the phase signals and a final frame rate control signal, and operating to output at least one driving voltage selection signal, a latch signal, and a gate control signal. In addition, the latch signal generator 9 is configured to output a latch signal (source latch) to the source driver 7 through the timing control unit 6. In the preferred embodiment, the timing control unit 6 has a single timing mode, and the control signal is provided to maintain a current frame rate of the single timing mode or to reduce the current frame rate of the single timing mode by reducing the number of the frames; or the timing control unit 6 has a dual timing mode, and the control signal is provided to replace the two timing mode with each other.

Refer still to FIG. 1, the source driver 71 connects to the timing control unit 6, and the source driver 71 is configured to accept the driving voltage selection signal, and to charge a pixel capacitance (not shown) by triggering an output voltage to convert through the latch signal. The gate driver 72 connects to the timing control unit 6, and the gate driver 72 is configured to output a voltage to the active matrix electrophoretic display according to a control of the gate control signal.

According to a structure of the present invention, the phase signals corresponded to the signal segments of each of the driving voltage signals are generated by the phase generator 3. The phase signal processor 4 processes an Nth phase signal and an (N+1)th phase signal of the phase signals according to the phase signals corresponded to the signal segments of each of the driving voltage signals, and generating a processing result. A control signal is operated for maintaining or reducing a frame rate of the active matrix electrophoretic display according to each of the processing results generated by each of the driving voltage signals. Finally, a union of a plurality of control signals generated through a plurality of the driving voltage signals is gotten, and the final frame rate control signal is obtained. The frame rate is reduced when the driving voltage signals do not change to achieve the effect of reducing power consumption.

As described above, an Nth phase signal and an (N+1)th phase signal of the phase signals are processed by the phase signal processor 4 according to the phase signals corresponded to the signal segments of each of the driving voltage signals, so as to determine to maintain or reduce a frame rate of the active matrix electrophoretic display. Thus, the conversion times of the outputting voltage of the source driver 71 and the gate driver 72 can be reduced to achieve the effect of reducing power consumption.

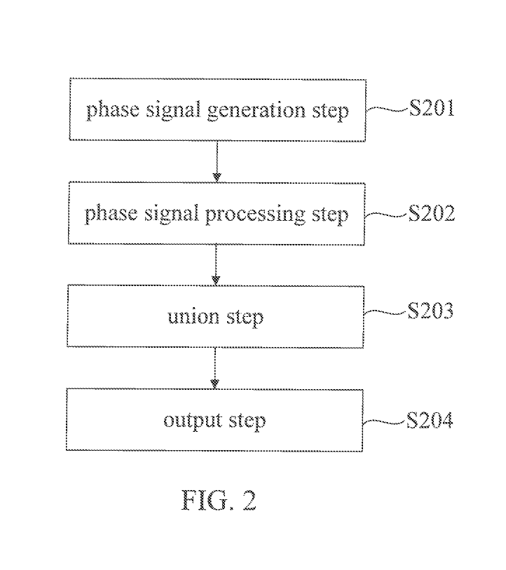

Refer to FIG. 2 with reference FIG. 1, a driving method of automatically adjusting a frame rate for an active matrix electrophoretic display according to the preferred embodiment of the present invention is illustrated, which drives the active matrix electrophoretic display by the driving device 100 of automatically adjusting a frame rate, wherein the driving method comprises a phase signal generation step 3201, a phase signal processing step S202, an union step S203, and an output step 3204. The detailed steps and principle of operation in the present invention will be described in detail hereinafter.

Refer to FIG. 2 with reference FIG. 1 in the phase signal generation step 3201, a plurality of driving voltage signals of a driving voltage signal storage 2 are read by a phase generator 3, and a plurality of phase signals corresponded to the signal segments are sequentially generated by the phase generator 3, wherein a plurality of signal segments of each of the driving voltage signals is divided by frames.

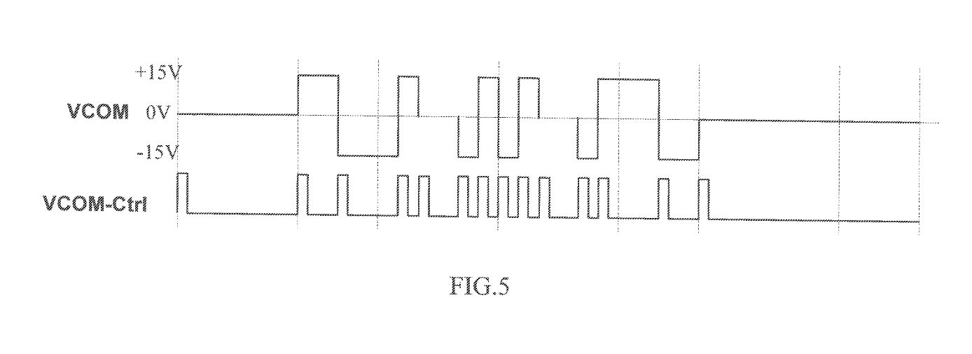

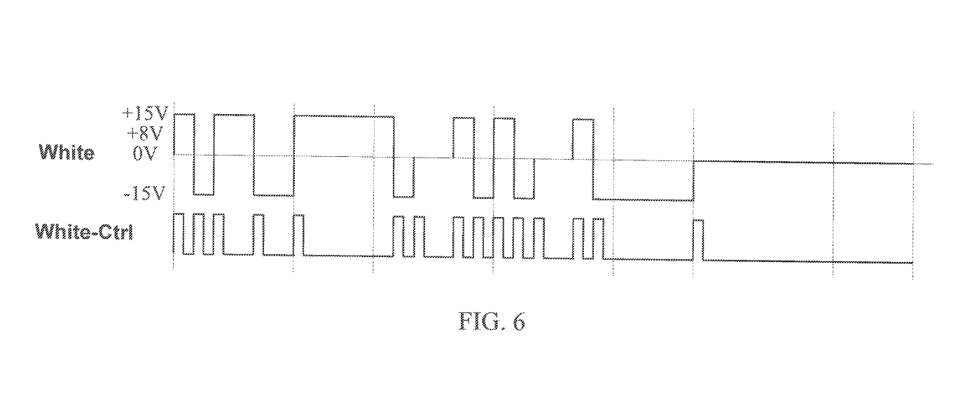

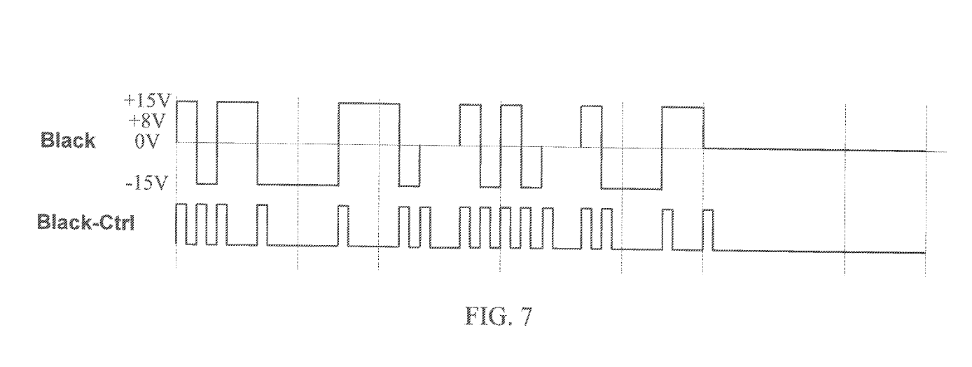

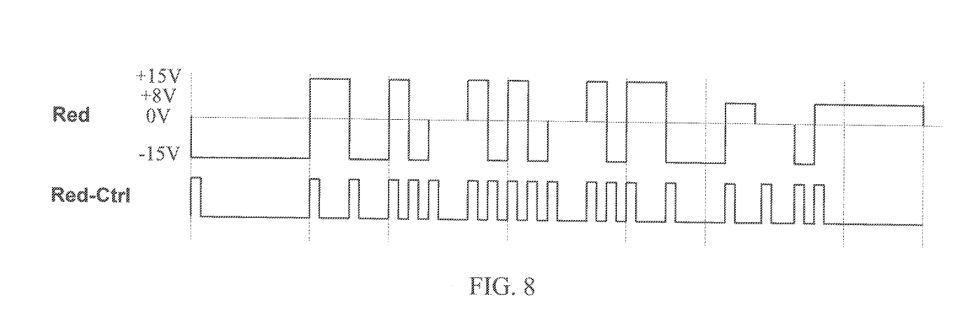

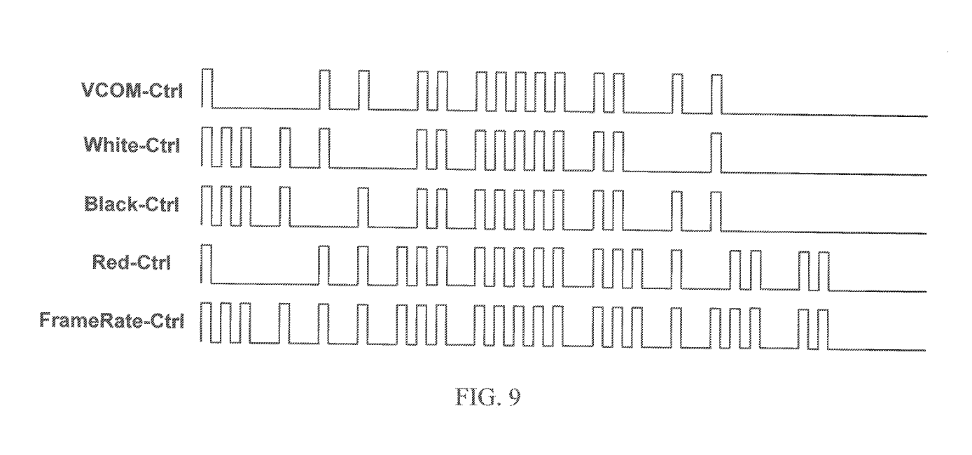

Refer to FIG. 2 with reference FIG. 1 in phase signal processing step S202, the phase signals of the phase generator 3 are accepted by a phase signal processor 4, an Nth phase signal and an (N+1)th phase signal of the phase signals are compared whether the Nth phase signal and the (N+1)th phase signal are the same or not according to the phase signals corresponded to the signal segments of each of the driving voltage signals, and a processing result is generated. A control signal is operated for maintaining or reducing a frame rate of the active matrix electrophoretic display according to each of the processing results generated by each of the driving voltage signals. For example, a first control signal (VCOM-Ctrl) is operated according to a first processing result generated by a first driving voltage signal (VCOM) in FIG. 5, a second control signal (White-Ctrl) is operated according to a second processing result generated by a second driving voltage signal (White) in FIG. 6, a third control signal (Black-Ctrl) is operated according to a first processing result generated by a third driving voltage signal (Black) in FIG. 7, and a fourth control signal (Red-Ctrl) is operated according to a first processing result generated by a fourth driving voltage signal (Red) in FIG. 8, wherein the reduced frame rate of the active matrix electrophoretic display is 1/2 to 1/16 of the kept frame rate of the active matrix electrophoretic display, and a high level of the control signals represents to maintain a current frame rate, and a low level of the control signals represents to reduce the frame rate.

Furthermore, in other embodiment, the phase signal processing step S202 also includes: detecting the Nth phase signal and the (N+1)th phase signal of the phase signals to determine whether the Nth phase signal and the (N+1)th phase signal are belonged to a driving voltage setting or not, and generating a processing result, wherein the driving voltage setting has a setting voltage and a number of frames keeping the setting voltage.

Refer to FIG. 2 with reference FIG. 1 in the union step S203, an union of a plurality of control signals generated through a plurality of the driving voltage signals is gotten by a union circuit 8, and a final frame rate control signal is obtained, wherein a high level of the final frame rate control signal represents to maintain the frame rate, and a low level of the final frame rate control signal represents to reduce the frame rate. For example, a union of the first control signal (VCOM-Ctrl), the second control signal (White-Ctrl), the third control signal (Black-CM), and the fourth control signal (Red-Ctrl) is gotten, and a final frame rate control signal (FrameRate-Ctrl) is obtained.

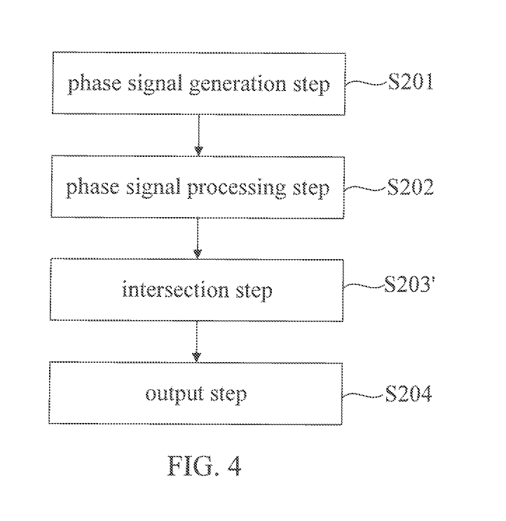

Refer to FIG. 4 with reference FIG. 3 in another preferred embodiment, the driving method further comprises an intersection step S203′, after the phase signal processing step S202, an intersection of a plurality of control signals generated through a plurality of the driving voltage signals is gotten by a intersection circuit 8′, and a final frame rate control signal is obtained, wherein a high level of the final frame rate control signal represents to reduce the frame rate, and a low level of the final frame rate control signal represents to maintain the frame rate.

Refer to FIG. 2 with reference FIG. 1 in the output step S204, the image data, the phase signals, and the final frame rate control signal are accepted, and at least one driving voltage selection signal, a latch signal, and a gate control signal are operated to output.

As described above, an Nth phase signal and an (N+1)th phase signal of the phase signals are processed by the phase signal processor 4 according to the phase signals corresponded to the signal segments of each of the driving voltage signals, so as to determine to maintain or reduce a frame rate of the active matrix electrophoretic display. Thus, the conversion times of the outputting voltage of the source driver 71 and the gate driver 72 can be reduced to achieve the effect of reducing power consumption.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A driving device of automatically adjusting a frame rate for an active matrix electrophoretic display, comprising:
a driving voltage signal storage configured to store at least one driving voltage signal, wherein the at least one driving voltage signal is provided to drive an active matrix electrophoretic display to display at least one color, and a plurality of signal segments of each of the at least one driving voltage signals is divided by frames;
a phase generator electrically connected to the driving voltage signal storage and configured to read the at least one driving voltage signal and sequentially generating a plurality of phase signals corresponded to the signal segments;
a phase signal processor electrically connected to the phase generator and configured to accept the phase signals and processing an Nth phase signal and an (N+1)th phase signal of the phase signals, and generating a processing result, wherein N is a positive integer;
an image data storage unit configured to store an image data;
a timing control unit connected to the image data storage unit, the phase generator and the phase signal processor, and configured to accept the image data, the phase signals and a final frame rate control signal, and operating to output at least one driving voltage selection signal, a latch signal, and a gate control signal;
a source driver connected to the timing control unit and configured to charge a pixel capacitance by triggering an output voltage to convert through the latch signal; and
a gate driver connected to the timing control unit and configured to output a voltage to the active matrix electrophoretic display according to a control of the gate control signal;
wherein the phase signal processor generates a control signal which is configured to maintain or reduce a frame rate of the active matrix electrophoretic display according to the processing result.

2. The driving device according to claim 1, wherein the phase signal processor is configured to compare the Nth phase signal with the (N+1)th phase signal of the phase signals to determine whether the Nth phase signal and the (N+1)th phase signal are the same or not, and to generate a processing result.

3. The driving device according to claim 1, wherein the phase signal processor is configured to detect the Nth phase signal and the (N+1)th phase signal of the phase signals to determine whether the Nth phase signal and the (N+1)th phase signal are belonged to a driving voltage setting or not, and to generate a processing result, wherein the driving voltage setting has a setting voltage and a number of frames keeping the setting voltage.

4. The driving device according to claim 1, wherein the driving device further comprises a union circuit configured to get a union of a plurality of control signals generated through a plurality of the driving voltage signals, and operating to obtain the final frame rate control signal.

5. The driving device according to claim 1, wherein the driving device further comprises an intersection circuit configured to get an intersection of a plurality of control signals generated through a plurality of the driving voltage signals, and operating to obtain the final frame rate control signal.

6. The driving device according to claim 1, wherein the timing control unit has a single timing mode, and the control signal is provided to maintain a current frame rate of the single timing mode or to reduce the current frame rate of the single timing mode by reducing the number of the frames.

7. The driving device according to claim 1, wherein the timing control unit has a dual timing mode, and the control signal is provided to replace the two timing mode with each other.

8. A driving method of automatically adjusting a frame rate for an active matrix electrophoretic display, comprising steps of:
a phase signal generation step for reading at least one driving voltage signal and sequentially generating a plurality of phase signals corresponded to a plurality of signal segments, wherein the signal segments is divided by frames;
a phase signal processing step for accepting the phase signals and processing an Nth phase signal and an (N+1)th phase signal of the phase signals, and generating a processing result, and generating a control signal for maintaining or reducing a frame rate of the active matrix electrophoretic display according to the processing result, wherein N is a positive integer; and
an output step for accepting the image data, the phase signals and a final frame rate control signal, and operating to output at least one driving voltage selection signal, a latch signal, and a gate control signal.

9. The driving method according to claim 8, wherein the phase signal processing step includes: comparing the Nth phase signal with the (N+1)th phase signal of the phase signals to determine whether the Nth phase signal and the (N+1)th phase signal are the same or not, and to generating a processing result.

10. The driving method according to claim 8, wherein the phase signal processing step includes: detecting the Nth phase signal and the (N+1)th phase signal of the phase signals to determine whether the Nth phase signal and the (N+1)th phase signal are belonged to a driving voltage setting or not, and generating a processing result, wherein the driving voltage setting has a setting voltage and a number of frames keeping the setting voltage.

11. The driving method according to claim 8, wherein the driving method further comprises a union step, after the phase signal processing step, for getting a union of a plurality of control signals generated through a plurality of the driving voltage signals, and operating to obtain the final frame rate control signal.

12. The driving method according to claim 8, wherein the driving method further comprises an intersection step, after the phase signal processing step, for getting an intersection of a plurality of control signals generated through a plurality of the driving voltage signals, and operating to obtain the final frame rate control signal.
